(19) United States
(12) Patent Application Publication
(10) Pub. No.: US 2007/0101401 A1
(43) Pub. Date: May 3, 2007

(54) Method and apparatus for super secure network authentication

(76) Inventors: Denise Marie Genty, Austin, TX (US); Shawn Patrick Mullen, Buda, TX (US); James Stanley Tesauro, Austin, TX (US)

Correspondence Address: IBM CORP (YA);C/O YEE & ASSOCIATES PC, P.O. BOX 802333, DALLAS, TX, 75380, US

(21) Appl. No.: 11/260,609

(22) Filed: Oct. 27, 2005

(51) Int. Cl. H04L 9/32

(52) U.S. Cl. 726/3

(57) ABSTRACT

A method, apparatus, and computer usable program code to receive a request from a user to access a network to form a received request, wherein the received request contains encrypted access information encrypted by a hardware security module on a client data processing system using a first key. The decryption of the encrypted access information occurs using the second key associated with the first key to form the decrypted information. An authorization process is performed using the decrypted information. The user is allowed access to the resource if the authorization process is successful.

### BACKGROUND OF THE INVENTION

1. Field of the Invention

The present invention relates generally to an improved data processing system and in particular to a method and apparatus for accessing resources. Still more particularly, the present invention relates to a computer implemented method, apparatus, and computer usable program code for authenticating users to access a network.

2. Description of the Related Art

Today, most organizations employ a network of some sort in day to day activities and in conducting business. These networks may take various forms, such as a local area network (LAN), a wide area network (WAN), or an intranet. Personnel in these organizations access resources through these networks. Additionally, many organizations conduct business or other activities through the Internet in which access to certain resources on their network occurs through the Internet. In increasing flexibility and productivity, some corporations make it possible for employees to work remotely. An employee may work remotely in a number of different locations, such as at home or at a customer site. Organizations go to great effort and expense to ensure that employee issued data processing systems, such as laptop computers, are up to date with security patches, the latest firewall systems, and virus protection systems. These different updates and applications are included on these types of data processing systems to reduce the possibility that someone will compromise an employee's laptop and break into the organization's network. Organizations know that hackers typically do not break in via a corporate firewall or by hacking a strong encryption algorithm. Further, organizations have recognized that the easiest way to break into a corporate network is to break into a weakly protected remote data processing system that is connected to the organization's network.

Although organizations provide laptops and other computer systems that are up to date with respect to security patches, firewalls, and virus protection applications, a hole in this process occurs when an employee installs the organization's remote connection software on their own personal data processing systems. An employee may install connection software on their own data processing system for the convenience of working at a desktop instead of a laptop or to avoid having to carry their laptop back and forth from work. One problem with this situation is that the employee's personal data processing system may not have the latest security patches or virus protection. Further, it is not possible for the organization to set the security level for these personal systems. One solution is to analyze a remote data processing system such as the connectivity network. Such a process may be impractical because of the time delay it takes to connect to the network and because a virus may propagate within seconds of connecting to the network.

As a result, viruses or other malicious code may more easily find its way onto a personal data processing system, and in turn, onto the organization's network.

### SUMMARY OF THE INVENTION

The present provides a method, apparatus, and computer usable program code to receive a request from a user to access a network to form a received request, wherein the received request contains encrypted access information encrypted by a hardware security module on a client data processing system using a first key. The decryption of the encrypted access information occurs using the second key associated with the first key to form the decrypted information. An authorization process is performed using the decrypted information. The user is allowed access to the resource if the authorization process is successful.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a diagram illustrating components used for super secure network authentication in accordance with an illustrative embodiment of the present invention;

FIG. 4 is a flowchart of a process for generating a request to access a resource in accordance with an illustrative embodiment of the present invention; and

FIG. 5 is a flowchart of a process for authenticating a request in accordance with an illustrative embodiment of the present invention.

### DETAILED DESCRIPTION OF THE PREFERRED EMBODIMENT

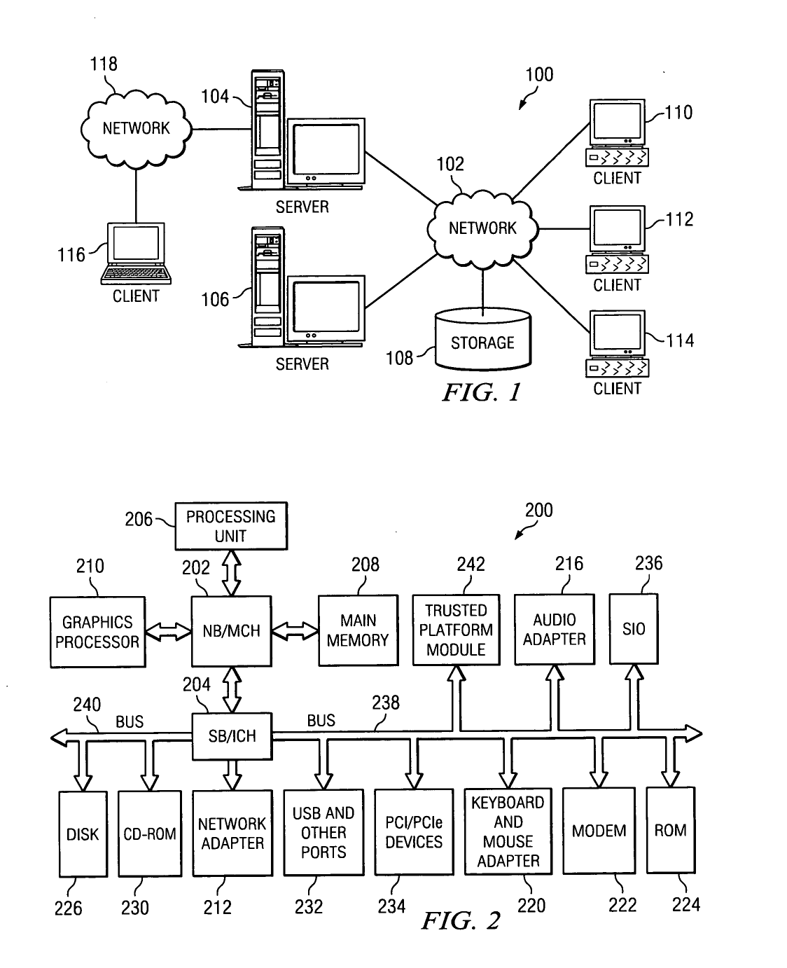

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In these examples, a remote client, such as client 116 may desire access to resources within network 102. Client 116 may send a request across network 118 to server 104 to request access to the resource. In these examples, network 118 may be an unsecured network, such as the internet. The aspects of the present invention provide for a secure authentication process to access network 102 resources within network 102. The resource may take various forms, such as an entire network or may be, for example, without limitation a database, a particular directory, or set of files. These other resources may be located in the network or on a single data processing system, such as server 104.

In the depicted example, network 118 is the Internet with network 118 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Additionally, data processing system 200 when implemented as a client includes trusted platform module (TPM) 242. Trusted platform module 242 is a hardware security module. In these examples, trusted platform module 242 contains keys used to encrypt information. Trusted platform module 242 may be employed to encrypt security sensitive information. In these examples, access to trusted platform module 242 occurs through a device driver. As a result, different applications may make calls or send information to trusted platform module 242 for processing.

The aspects of the present invention provide a computer implemented method, apparatus, and computer usable program code for super secure network authentication. A user's login identifier and password are bound to a particular data processing system. In this manner, only data processing systems with approved security levels are able to connect to an organization's network. The aspects of the present invention ensure this feature to the extent that even if every file is copied from an issued or authorized data processing system to an unauthorized one, only the authorized data processing system is able to connect to the network. As a result, even is the employee's login identifier, password, and secure identification card are stolen, the thief is unable to break in without also having the organization's laptop that is authorized for that particular user.

The aspects of the present invention recognize that current security solutions are software based and do not have the security protection of hardware. The aspects of the present invention combine authorizing a user along with the secure features of a trusted platform module. A portion of the information in the request is encrypted. In particular, when a request is received from a user to access a network, a portion of the request is decrypted using a key to perform the encrypted information. The authorization is performed using this decrypted information as well as other information included in the request. If the authentication is successful, the user is then allowed to access the resource.

In the illustrative examples, the information that is encrypted is a password. If properly processed, the password is encrypted using a first key on the client data processing system. This first key is accessible by hardware security module on that client data processing system. The encrypted password and the user identifier are sent in the request to a server or other device. The password is decrypted using a second key associated with the first key. The decrypted password and the user identifier are then employed in an authorization process to determine whether the user is allowed to access the requested resource. In these examples, the first key is a private key and the second key is a public key for the private key. The private key is only accessible by the hardware security module such that any other attempts to encrypt the password are unsuccessful without the private key. As a result, any decryption of the password results in an improper or unrecognizable password for the authorization process.

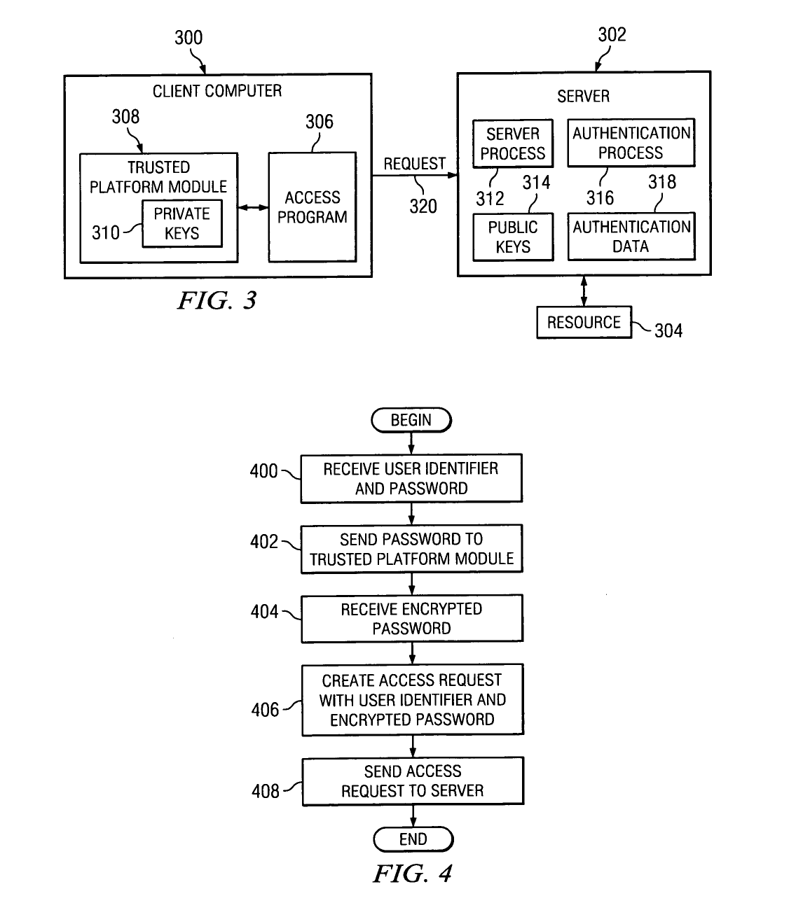

Turning now to FIG. 3, a diagram illustrating components used for a super secure network authentication system is depicted in accordance with an illustrative embodiment of the present invention. In this example, a user at client computer 300 contacts server 302 to access resource 304. Client computer 300 may be implemented using data processing system 200 in FIG. 2 in these examples. Similarly, server 302 may be implemented using data processing system 200 in FIG. 2. In these examples, resource 304 is a network. Resource 304 may take other forms, for example, a database, a directory, a printer, or any other information or resource for which restricted access is desired.

In these examples, the user enters a user identifier and password into access program 306 then encrypts the password to trusted platform module 308. Access program 306 may be, for example, a dialer program or other programs used to establish a connection with an end point, such as server 302. Trusted platform module 308 is located in client computer 300 and has access to private keys 310.

Trusted platform module 308, as described above is a hardware device located in client computer 300. Trusted platform module 308 encrypts the password using a private key from private keys 310. This private key is a private key assigned to the user attempting to access resource 304. Trusted platform module 308 identifies the private key for use in encrypting the password based on the user identifier entered into access program 306. Trusted platform module 308 returns the encrypted password to access program 306, which then sends request 320 to server 302. In this example, request 320 contains the user identifier and the encrypted password. Additionally, request 320 also may identify the resource for which access is desired. The request may include attributes, such as a desired IP address of a server.

Server process 312 receives request 320. Server process 312 identifies a public key from public keys 314 based on the user identifier in request 320. Server process 312 decrypts the encrypted password using the identified public key and then passes the decrypted password and the user identifier to authentication process 316. Authentication process 316 determines whether the particular user is permitted to access the resource, such as a network resource or IP address. Additionally, the password is used to verify whether the user is the actual user requesting access to resource 304. If authentication process 316 successfully authenticates the request, client computer 300 is then provided access to resource 304. In these examples, resource 304 is an IP address of a network resource.

In these examples, authentication process 316 may be implemented using any type of authentication system. For example, a remote authentication dial-in user service (RADIUS) system may be employed. This type of system requires entry of a user name and password to access a network. The information is passed from a client to a network access server device over a point-to-point protocol and then to a RADIUS server over the RADIUS protocol. The RADIUS server checks to see whether the information is correct using various authentication schemes. For example, a challenge handshake authentication protocol (CHAP), or an extensible authentication protocol (EAP) may be employed. RADIUS is described in RFC2865, June 2000.

In these examples, server 302 provides access to a resource, such as network 102 in FIG. 1. If an improper encryption of the key occurs, the password can still be decrypted but results in an incorrect password with no access to resource 304. The components in client computer 300 and in server 302 form the super secure network authorization system. With this system, access to a resource is allowed only from a particular data processing system assigned to a user. As a result, if a user identification and password are stolen, an unauthorized user is unable to access the resource unless the unauthorized user also has the user's data processing system.

Turning now to FIG. 4, a flowchart of a process for generating a request to access a resource is depicted in accordance with an illustrative embodiment of the present invention. The process illustrated in FIG. 4 may be implemented in an access program, such as access program 306 in FIG. 3.

The process begins by receiving the user identifier and password (step 400). The process sends the password to a trusted platform module (step 402). In turn, an encrypted version of the password is received (step 404). The process then creates an access request with the user identifier and the encrypted password (step 406). This request also may identify the resource for which access is desired. The access request is then sent to a server (step 408) with the process terminating thereafter.

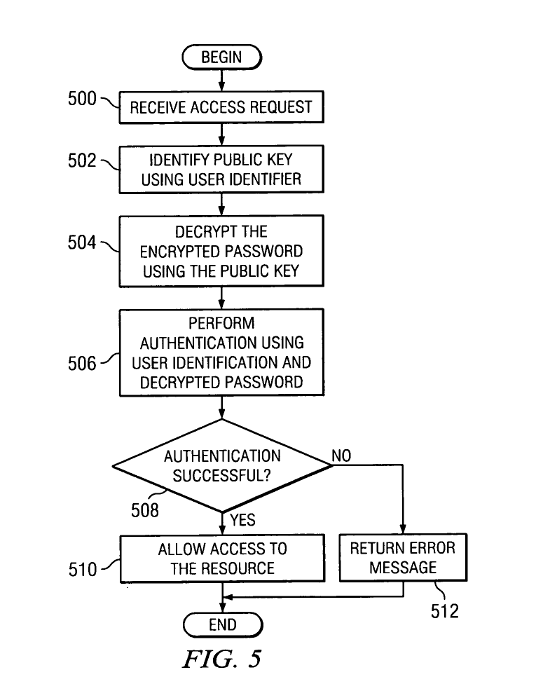

Turning to FIG. 5, a flowchart of a process for authenticating a request is depicted in accordance with an illustrative embodiment of the present invention. The process illustrated in FIG. 5 may be implemented in a server, such as server 302 in FIG. 3. In particular, the process may be implemented using server process 312 and authentication process 316 in FIG. 3.

The process begins by receiving an access request (step 500). The process identifies the public key using the user identifier contained in the access request (step 502). Thereafter, the process decrypts the encrypted password using the public key (step 504). The process then performs authentication using the user identifier and the decrypted password (step 506). Next, a determination is made as to whether the authentication is successful (step 508).

In these examples, the authentication is successful if the user and the password are both present with respect to the resource in which access is being requested. In other words, step 508 determines whether the user is allowed access to the resource and also determines whether the request actually comes from the user by determining whether the password is correct. If the authentication is successful, the process allows access to the resource (step 510) with the process terminating thereafter. Otherwise, an error message is returned (step 512) with the process terminating thereafter. The error message may be, for example, an access reject message.

Thus, the aspects of the present invention provide a computer implemented method, apparatus, and computer usable program code for providing secure access to resources. In these examples, a trusted platform module is used to encrypt a password on the client data processing system. A request for access is sent using a user identifier and the encrypted password. This encrypted password is then decrypted. The decrypted key is then used with the user identifier in an authentication process in these examples. As a result, proper authentication can only occur if the request comes from the user at the client data processing system. In these examples, the encrypted information is the password. Depending on the particular implementation, other information could be encrypted, such as the resource requested in addition to or in place of the password. In addition to preventing unauthorized access by unauthorized users, the aspects of the present invention also ensure that the user accesses the resource only through hardware that has been selected or set to security levels required by an organization. In this manner, threats, such as viruses and other malicious code being introduced into the resource is reduced.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for accessing a resource, the computer implemented method comprising:
receiving a request from a user to access a network to form a received request, wherein the received request contains encrypted access information encrypted by a hardware security module on a client data processing system using a first key;
decrypting the encrypted access information using a second key associated with the first key to form decrypted information;
performing an authentication process using the decrypted information; and
allowing the user access to the resource if the authentication process is successful.

2. The computer implemented method of claim 1, wherein the first key is a private key and the second key is a public key.

3. The computer implemented method of claim 2, wherein the private key is accessible only by the hardware security module.

4. The computer implemented method of claim 1, wherein the encrypted access information is at least one of a password and a user identifier.

5. The computer implemented method of claim 1, wherein the receiving, decrypting, performing, and allowing steps are performed one of a server data processing system, a router, or a switch.

6. The computer implemented method of claim 1, wherein the client data processing system is a laptop computer.

7. The computer implemented method of claim 1, wherein the resource is a network.

8. The computer implemented method of claim 1, wherein the resource is a database.

9. A network data processing system comprising:
a network;
a server data processing system connected to the network; and
a client computer in communication with the server through a communication link external to the network, wherein the client computer includes a hardware security module,
wherein the client encrypts a password used to request access to the network using the hardware security module with a private key to form an encrypted password, the client sends the encrypted password to the server data processing system in a request to access the network, the server data processing system decrypts the password using a public key that is associated with the private key to form a decrypted password, and the server data processing system determines whether to allow the client data processing system access to the network using the decrypted password.

10. A computer program product comprising:
a computer usable medium having computer usable program code for accessing a resource, said computer program product including:
computer usable program code for receiving a request from a user to access a network to form a received request, wherein the received request contains encrypted access information encrypted by a hardware security module on a client data processing system using a first key;
computer usable program code for decrypting the encrypted access information using a second key associated with the first key to form decrypted information;
computer usable program code for performing an authentication process using the decrypted information; and
computer usable program code for allowing the user access to the resource if the authentication process is successful.

11. The computer program product of claim 10, wherein the first key is a private key and the second key is a public key.

12. The computer program product of claim 11, wherein the private key is accessible only by the hardware security module.

13. The computer program product of claim 10, wherein the encrypted access information is at least one of a password and a user identifier.

14. The computer program product of claim 10, wherein the computer usable program code for receiving a request from a user to access a network to form a received request, wherein the received request contains encrypted access information encrypted by a hardware security module on a client data processing system using a first key, computer usable program code for decrypting encrypted access information using a second key associated with the first key to form decrypted information, computer usable program code for performing an authorization process using the decrypted information; and computer usable program code for allowing the user access to the resource if the authorization process is successful are performed one of a server data processing system, a router, or a switch.

15. The computer program product of claim 10, wherein the client data processing system is a laptop computer.

16. The computer program product of claim 10, wherein the resource is a network.

17. The computer program product of claim 10, wherein the resource is a database.

18. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to receive a request from a user to access a network to form a received request, wherein the received request contains encrypted access information encrypted by a hardware security module on a client data processing system using a first key; decrypt the encrypted access information using a second key associated with the first key to form decrypted information; perform an authorization process using the decrypted information; and allow the user access to the resource if the authorization process is successful.

19. The data processing system of claim 18, wherein the processor unit further executes the computer usable code, and wherein the first key is a private key and the second key is a public key.

20. The data processing system of claim 19, wherein the processor unit further executes the computer usable code, and wherein the private key is accessible only by the hardware security module.

21. The data processing system of claim 18, wherein the processor unit further executes the computer usable code, and wherein the encrypted access information is at least one of a password and a user identifier.

22. The data processing system of claim 18, wherein the processor unit further executes the computer usable code, and wherein the receiving, decrypting, performing, and allowing steps are performed one of a server data processing system, a router, or a switch.

23. The data processing system of claim 18, wherein the processor unit further executes the computer usable code, and wherein the client data processing system is a laptop computer.

24. The data processing system of claim 18, wherein the processor unit further executes the computer usable code, and wherein the resource is a network.

25. The data processing system of claim 18, wherein the processor unit further executes the computer usable code, and wherein the resource is a database.

26. A data processing system for accessing a resource, the data processing system comprising:
receiving means for receiving a request from a user to access a network to form a received request, wherein the received request contains encrypted access information encrypted by a hardware security module on a client data processing system using a first key;
decrypting means for decrypting encrypted access information using a second key associated with the first key to form decrypted information;
performing means for performing an authorization process using the decrypted information; and
allowing means for allowing the user access to the resource if the authorization process is successful.

27. The data processing system of claim 26, wherein the first key is a private key and the second key is a public key.

28. The data processing system of claim 27, wherein the private key is accessible only by the hardware security module.

29. The data processing system of claim 26, wherein the encrypted access information is at least one of a password and a user identifier.
